(19) United States
(12) Patent Application Publication
(10) Pub. No.: US 2003/0074203 A1
(43) Pub. Date: Apr. 17, 2003

(54) Systems and methods for electronic interaction

(76) Inventor: Barry Lynn, Hollywood, FL (US)

Correspondence Address: David W. Barman, 1101 NE 176 Terrance, North Miami Beach, FL, 33162, US

(21) Appl. No.: 09/733,157

(22) Filed: Dec. 8, 2000

Related U.S. Application Data
(60) Provisional application No. 60/170,068, filed on Dec. 10, 1999.

(51) Int. Cl. G06F 17/60

(52) U.S. Cl. 705/1

(57) ABSTRACT

The present invention relates to novel systems and methods for public and/or private electronic interaction between industries for purposes of transmitting selective information to targeted individuals or entities within such industries, such as, between homebuilders and real estate professionals to facilitate home purchase transactions.

### U.S. PATENT APPLICATION

This application for U.S. patent is filed as an application for U.S. patent under U.S.C., Title 35, §111(a), and claims priority to U.S. provisional application application, which was assigned Serial No. 60/170068 and filed on Dec. 10, 1999.

### FIELD OF THE INFORMATION

The present invention relates to novel systems and methods for public and/or private electronic interaction between industries for purposes of transmitting selective information to targeted individuals or entities within such industries, such as, between homebuilders and real estate professionals to facilitate home purchase transactions.

### BACKGROUND

In the homebuilding business, a homebuilder customarily pays a sales commissions to real estate brokers, agents and realtors in the event that clients, that they have referred, buy homes from or build homes through the homebuilder.

In one form of advertising, and from time to time, homebuilders engage in promotional campaigns by sending promotional materials to those members of the real estate industry. Because these materials are usually in print, homebuilders must pay for design, production, printing, mailing lists rentals, postage and mailing services. These promotional campaigns can be very costly and are usually time intensive. For example, costs for each promotional campaign can range from $400 to $4000 and can take several weeks to produce and send. Notwithstanding the high costs and time involved, it is estimated that only about 10% of the industry members reached by these promotional campaigns are professionals who want to do business with homebuilders. Moreover, the information promoted by the homebuilders in their promotional campaigns is quickly dated due to, for example, fluctuations in costs to homebuilders and interest rates, which requires the promotional campaigns to be frequently repeated with updates.

In addition, a homebuilder generally requires that real estate professionals accompany each client on each initial visit to the homebuilder's sales office in order for the professionals to register themselves and their clients, so that commissions will be paid to the appropriate professionals in the event sales are made to their clients. Unfortunately, because this requirement is very time consuming to the real estate professionals, it generally acts as a deterrence and hindrance to home purchases, as opposed to an incentive for home purchases by clients of real estate professionals.

In summary, the problems with the current methods employed by homebuilders to do business with real estate professionals are costly, slow, inefficient in reaching targeted markets, and time consuming, they provide promotional information which becomes quickly dated, and they in many instances, inhibit real estate professionals from doing business with homebuilders.

Consequently, there is a need for a system and method for homebuilders to efficiently, quickly and inexpensively reach targeted markets with current promotional and marketing information and to induce and encourage all real estate professionals to register their clients with homebuilders, without the disadvantages discussed above.

### SUMMARY OF THE INVENTION

The present invention overcomes and alleviates the above-mentioned drawbacks and disadvantages of doing business between industries through the discovery of novel systems and methods which permit public or private, immediate electronic interaction and communication between industries.

Generally speaking, the present invention enables each industry to selectively interact and communicate electronically with one another on demand in public or private forums through the internet without the costs and time disadvantages required heretofore. More specifically, the current invention allows each industry to provide current and complete information to one another instantaneously and to remain updated at all times, so that each industry benefits.

In the context of the real estate professional and homebuilder industries, the novel systems and methods of the present invention permit immediate electronic interaction between homebuilders and real estate professionals to facilitate home purchase transactions. Through the novel systems and methods of the current invention, homebuilders can continuously transmit current marketing and promotional information to real estate professionals to directly or indirectly induce them to encourage their clients to purchase homes from homebuilders. Also of importance, the novel systems and methods of the present invention afford real estate professionals the opportunity to electronically register their clients online with homebuilders of their choice without the necessity to resort to current methods or requiring in persona visits by the real estate professionals with their clients to homebuilders' sales offices and afford homebuilders with the opportunity to generally or specifically promote their inventory with complete and current information, without the necessity to resort to current methods of requiring homebuilders to engage in traditional promotional campaigns.

Accordingly, it should now be appreciated by those versed in this art that the novel systems and methods of the present invention eliminate the costs incurred by homebuilders for design, production, printing, mailing list rentals and postage associated with the traditional promotional campaigns. In addition, the novel systems and methods of the present invention permit the homebuilders to prepare and send the promotional information within minutes, thereby ensuring that all information remains current and reaches the targeted audiences, e.g., real estate professionals who want to do business with homebuilders, and to receive information from real estate professionals within minutes, then by reducing the time required for the homebuilders' sales staff to, for example, register those clients referred to them by the real estate professionals. The novel systems and methods of the present invention not only eliminate the necessity for real estate professionals to actually visit the sales offices of homebuilders with their clients for the purposes of registering their clients, they encourage real estate professionals who ordinarily do not do business with home builders to do so. Moreover, the novel systems and methods of the present invention permit real estate professionals to provide homebuilders with contact information on potential customers who they might otherwise not learn about.

The above features and advantages of the present invention will be better understood with reference to the following Detailed Description, Figs. and Example. It should also be understood that the particular systems and methods illustrating the present invention are exemplary only and not to be regarded as limitations of the present invention.

### BRIEF DESCRIPTION OF THE FIGS.

Reference is now made to the accompanying Figs. in which a more complete understanding of how the novel systems and methods of the present invention may be accomplished and practiced by reference to the following Detailed Description and Example, when considered together with the accompanying Figs.

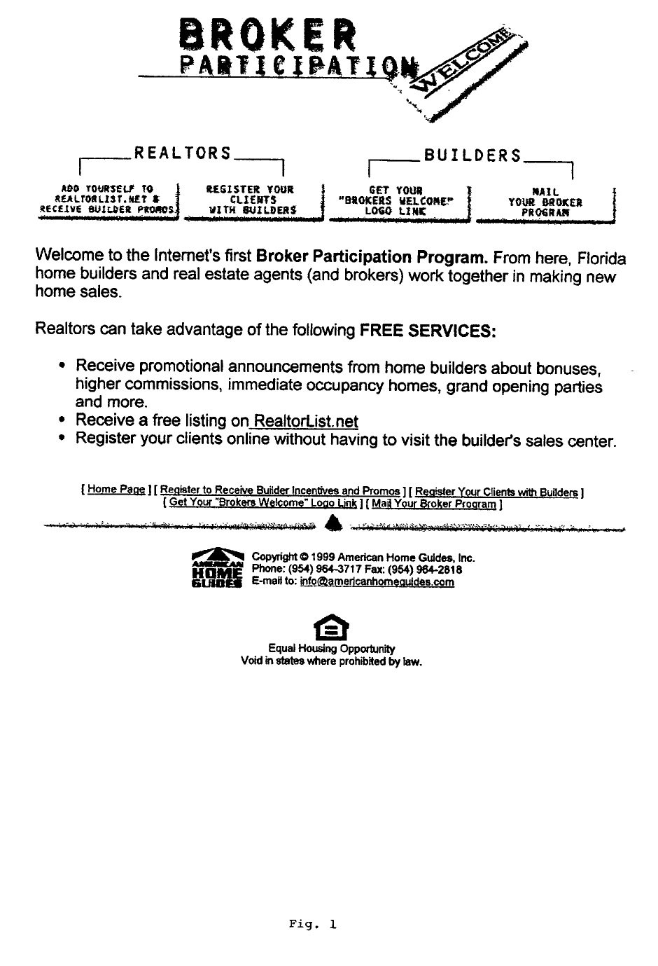

FIG. 1 is a home web page from which a homebuilder and a real estate professional can learn about the program and click links to begin using it.

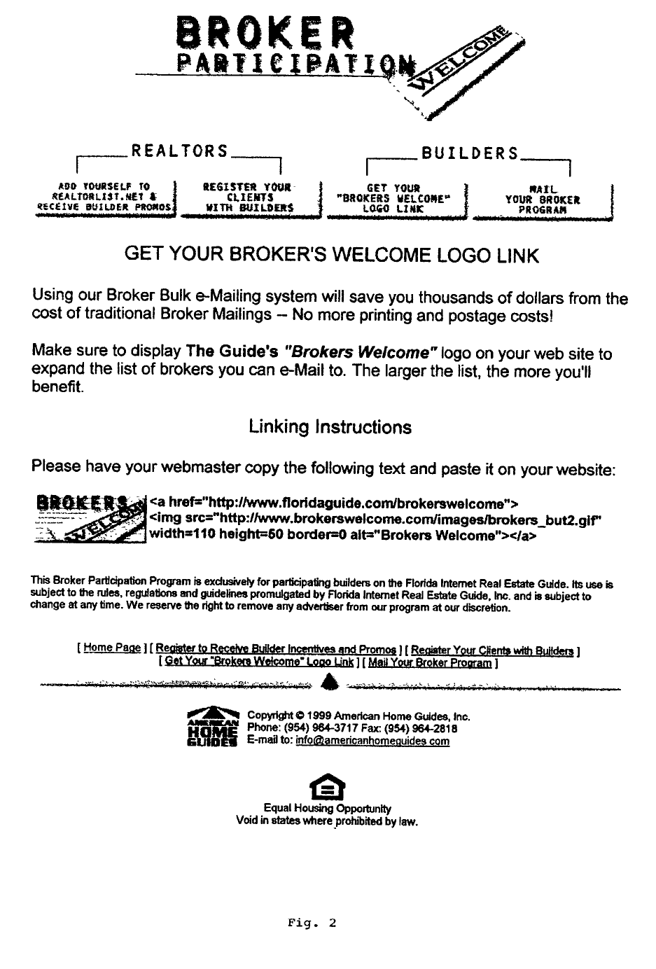

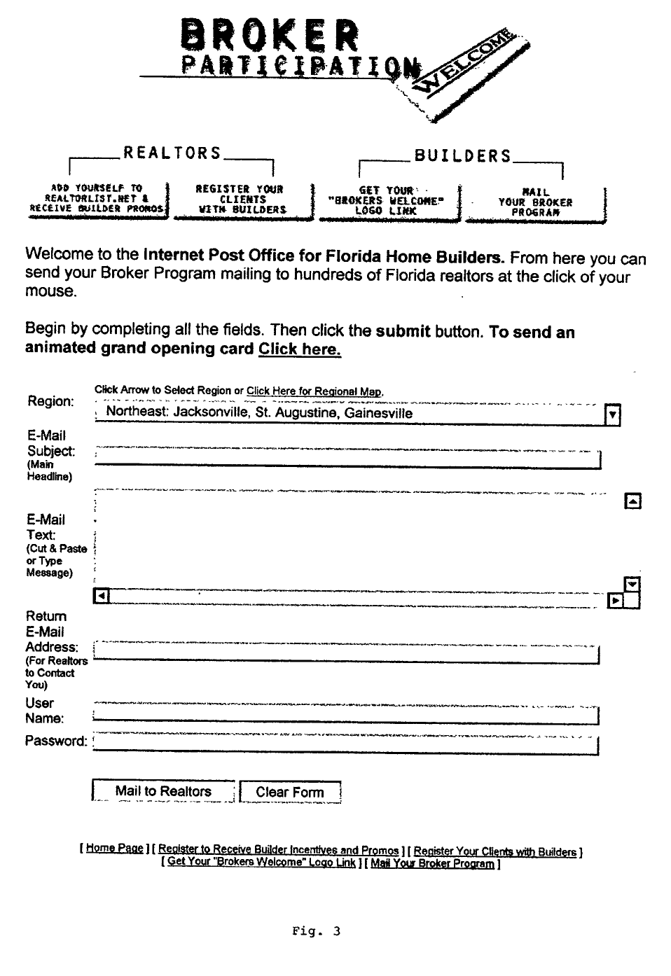

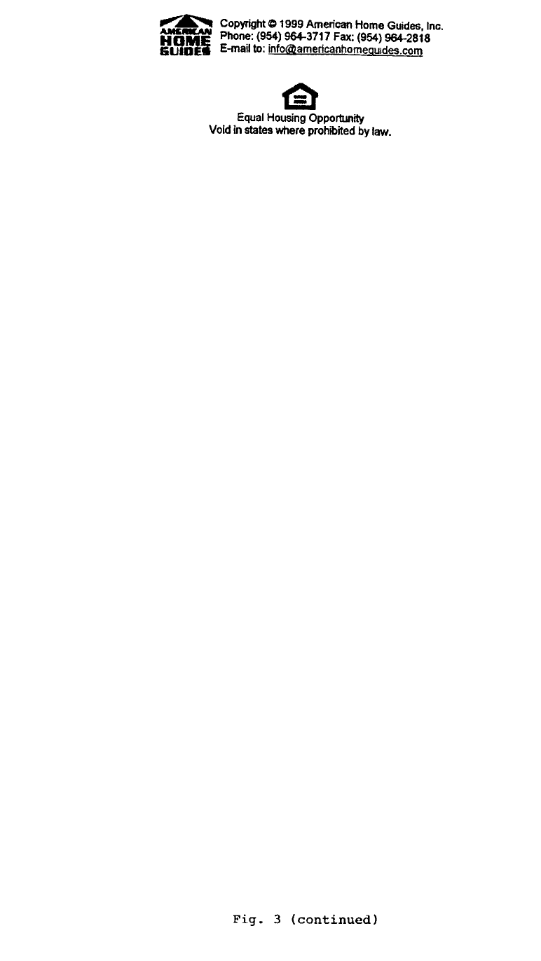

FIG. 2 is a web page that a homebuilder can obtain the logo link, so that he or she can add it to his or her web site in order to get more real estate professionals to participate in the program.

FIG. 3 is a web page that a homebuilder can bulk email to real estate professionals.

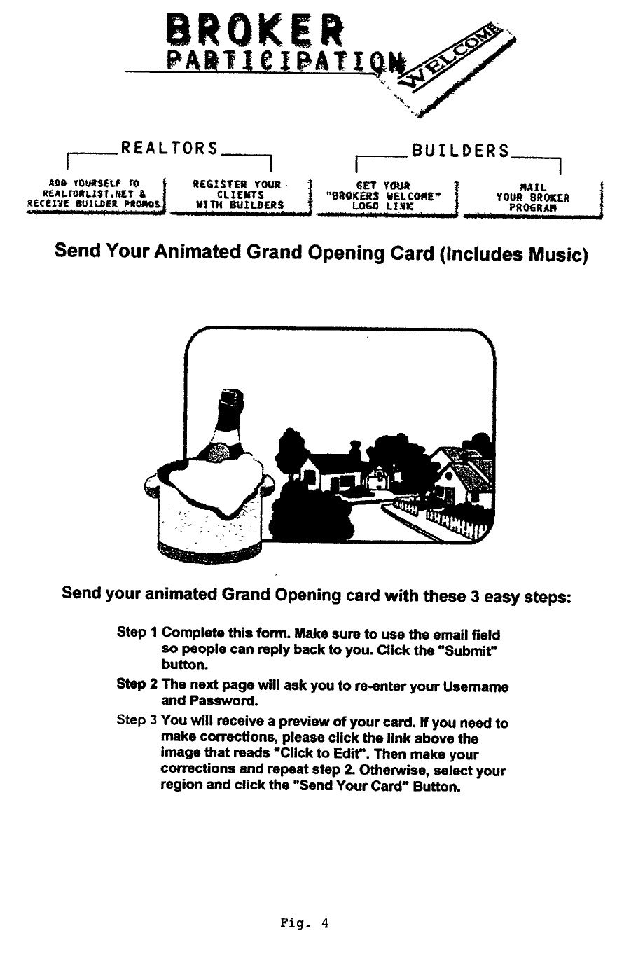

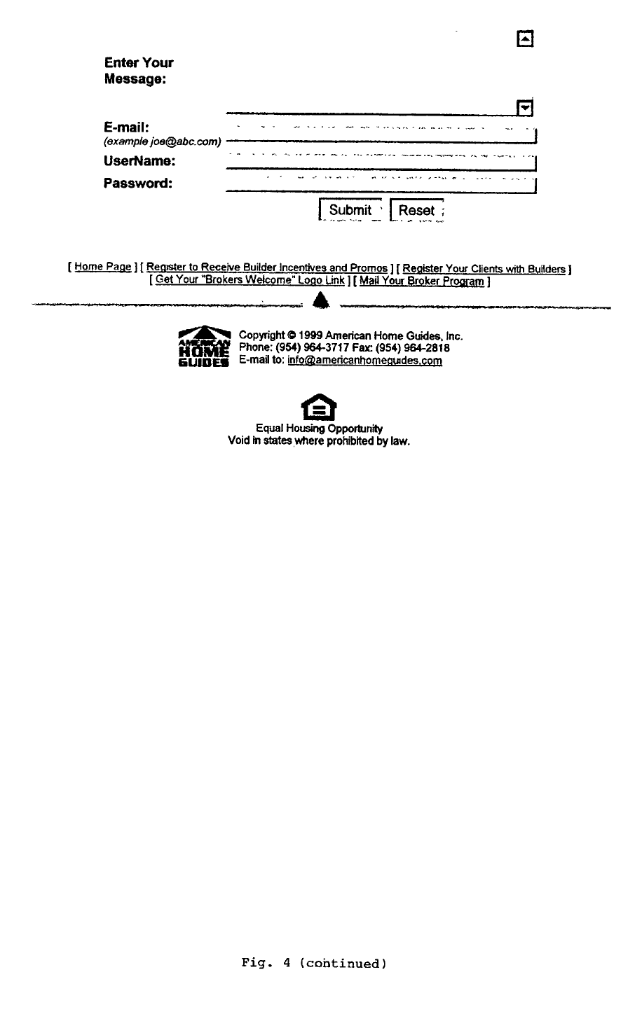

FIG. 4 is a web page that provides instruction for a homebuilder to bulk email a message to real estate professionals in a greeting card format.

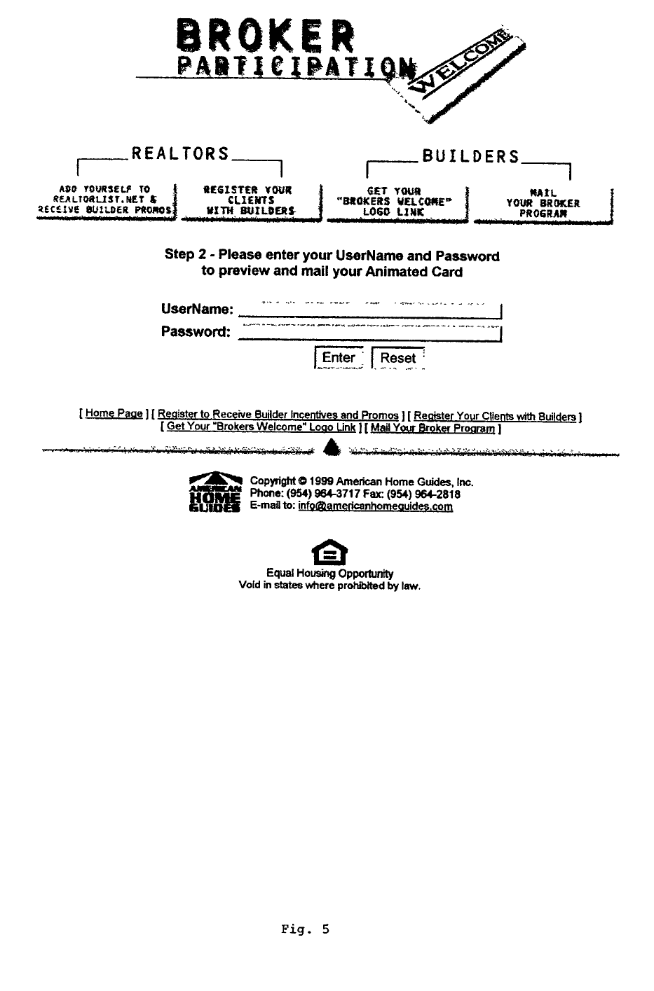

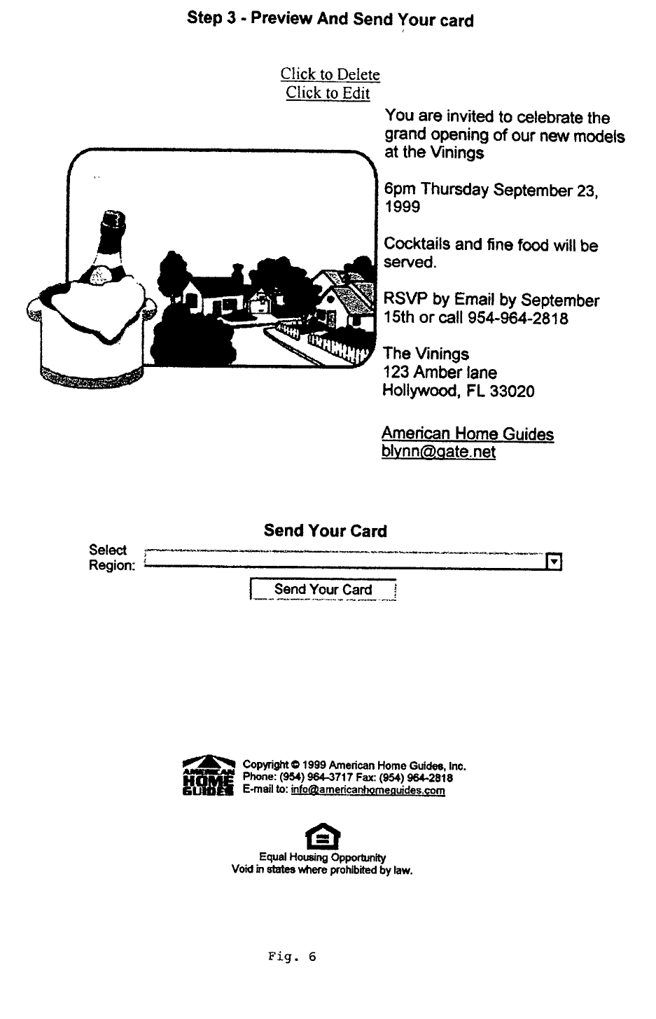

FIG. 5 is a web page that allows a homebuilder to preview and mail his or her animated greeting card.

FIG. 6 is a web page that is an example of how an animated card looks and provides the geographic selection and sending mechanism.

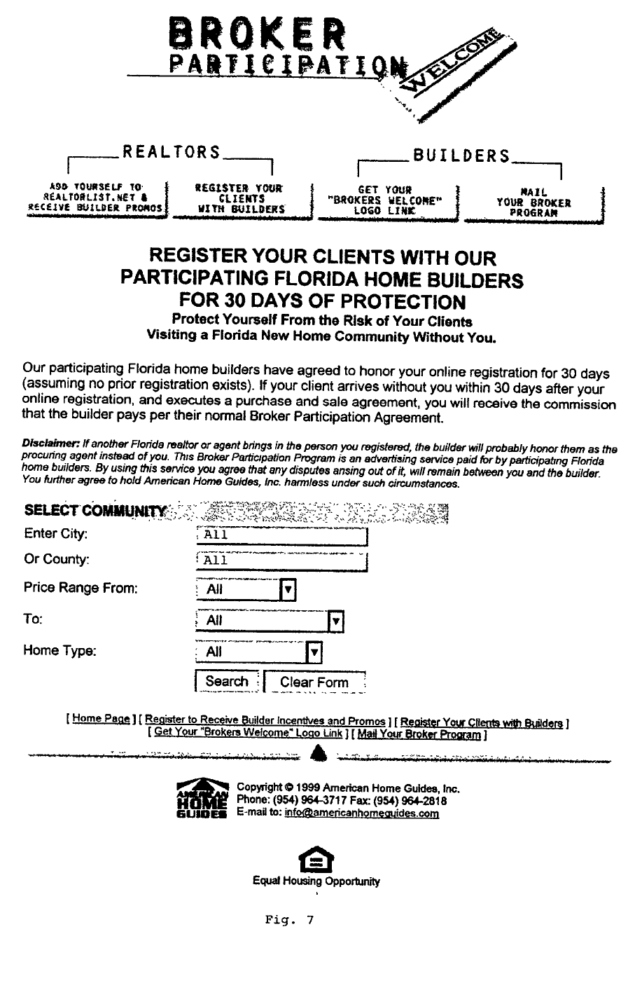

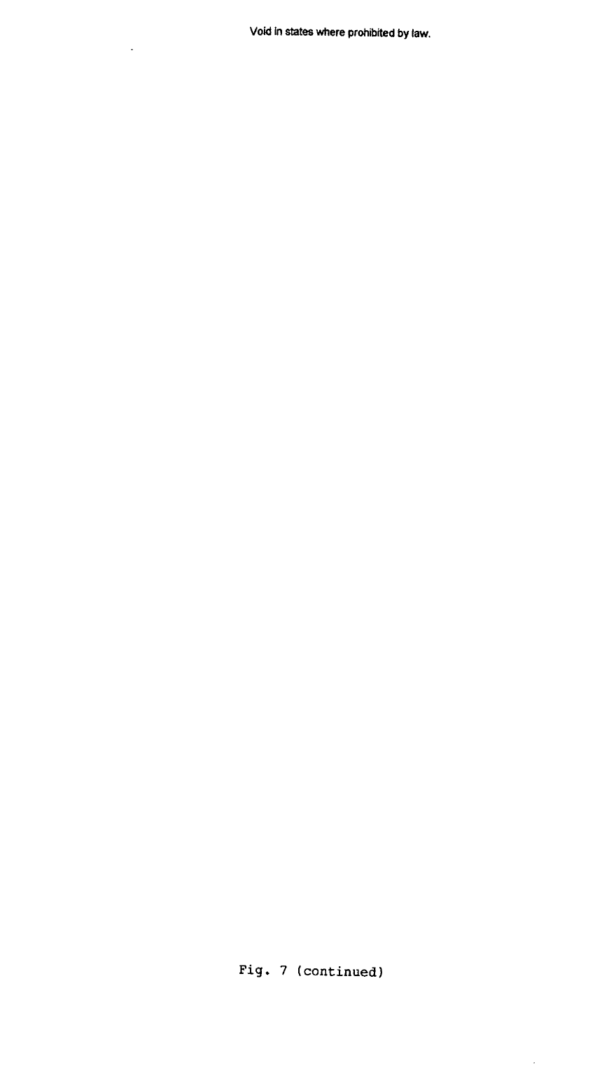

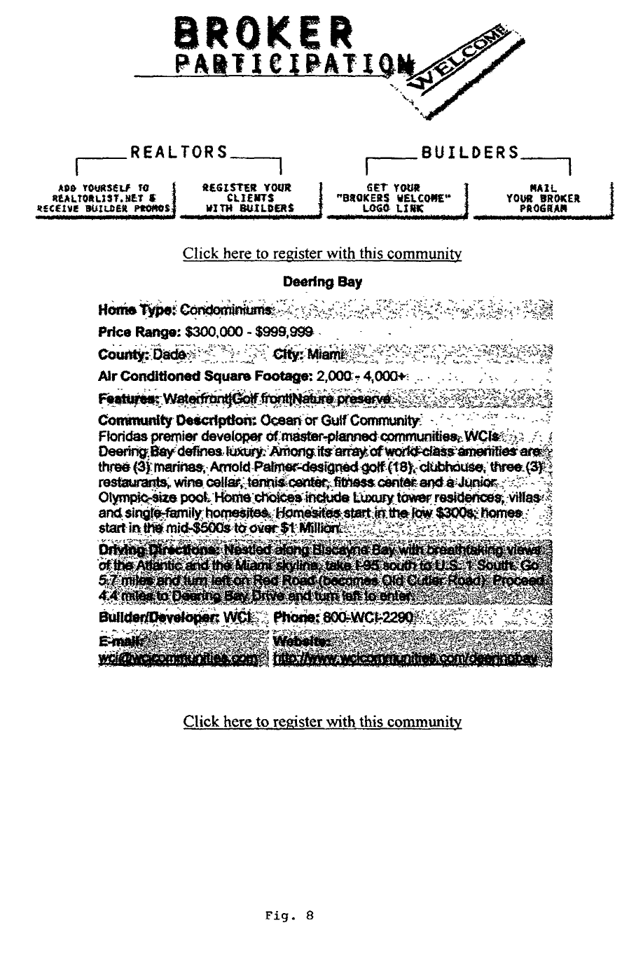

FIG. 7 is a web page that allows a real estate professional to locate communities where he or she can register his or her clients online.

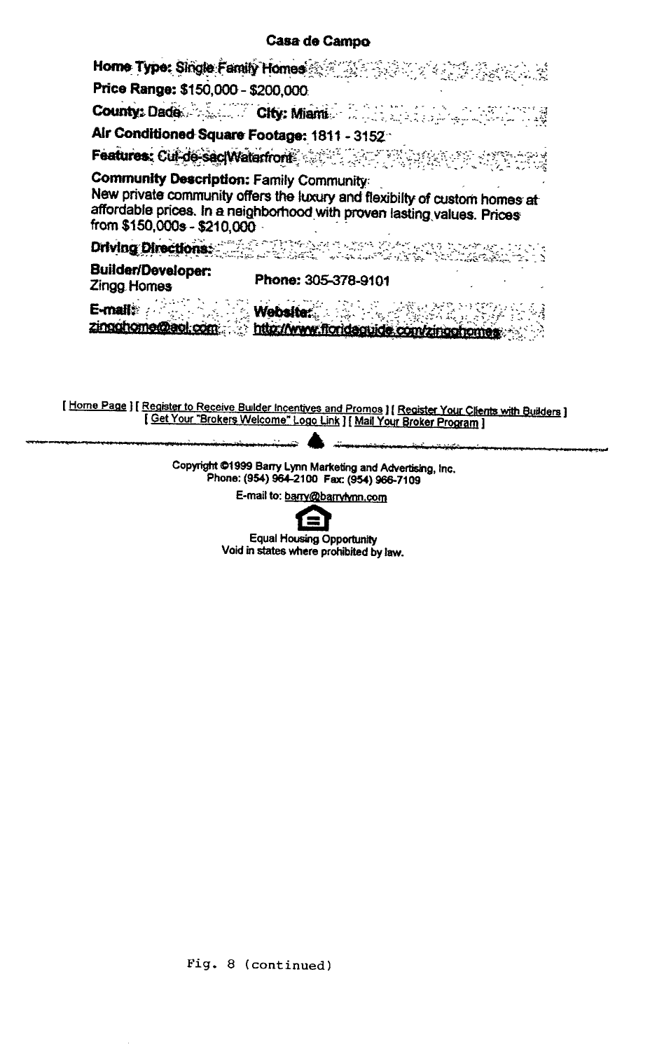

FIG. 8 is a web page that shows typical community listings.

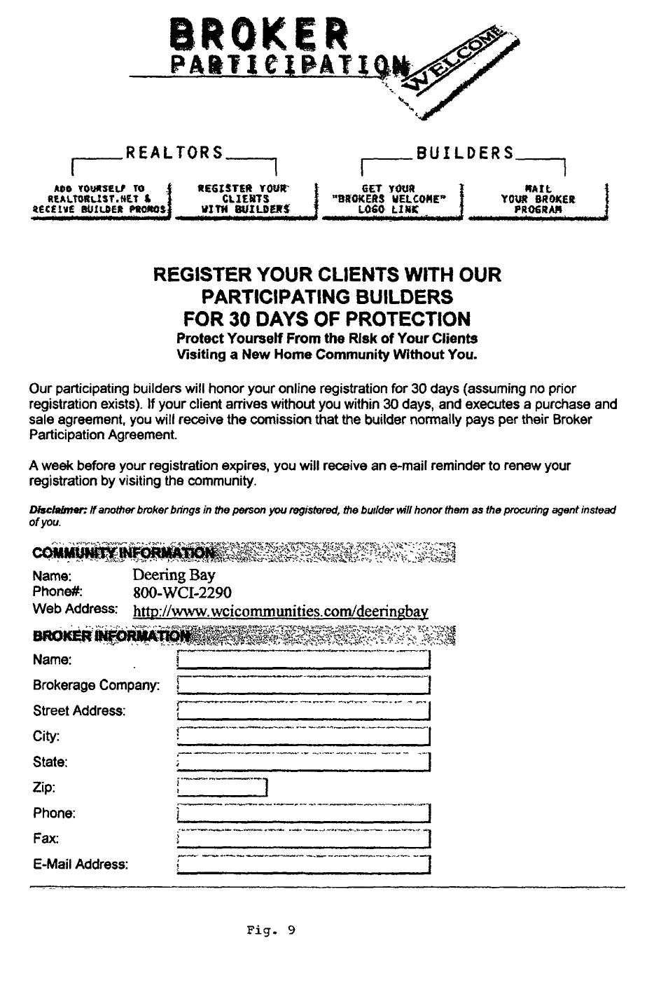

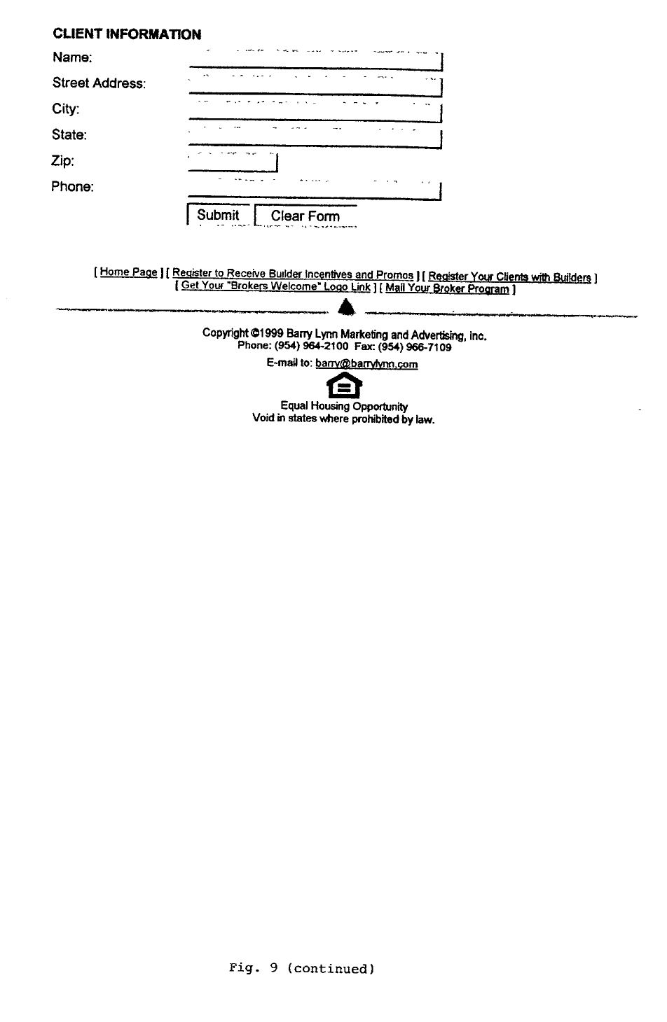

FIG. 9 is a registration web page that appears when a real estate professional selects a community listing, and when the real estate professional performs the actual online registration.

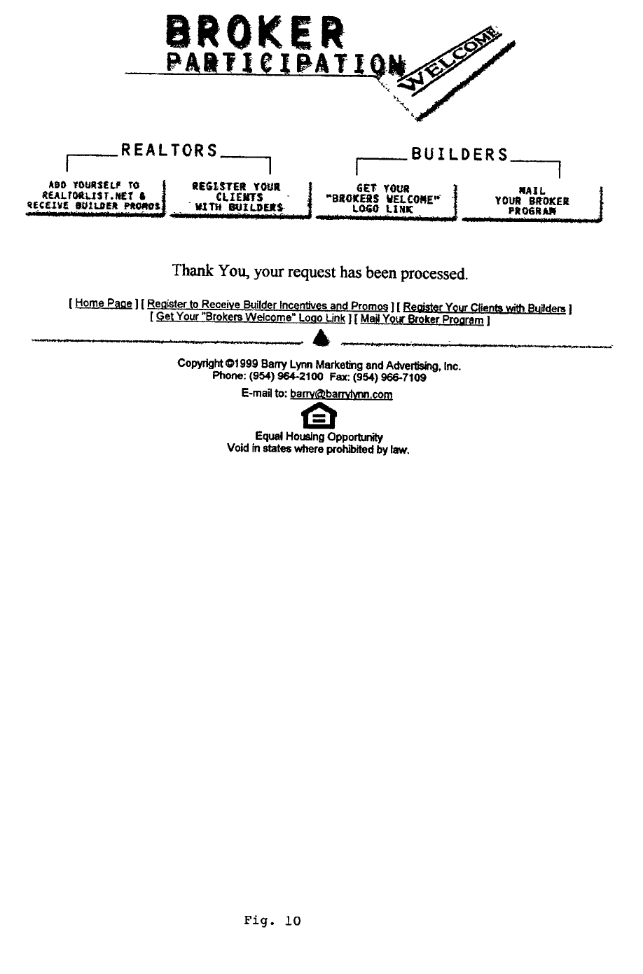

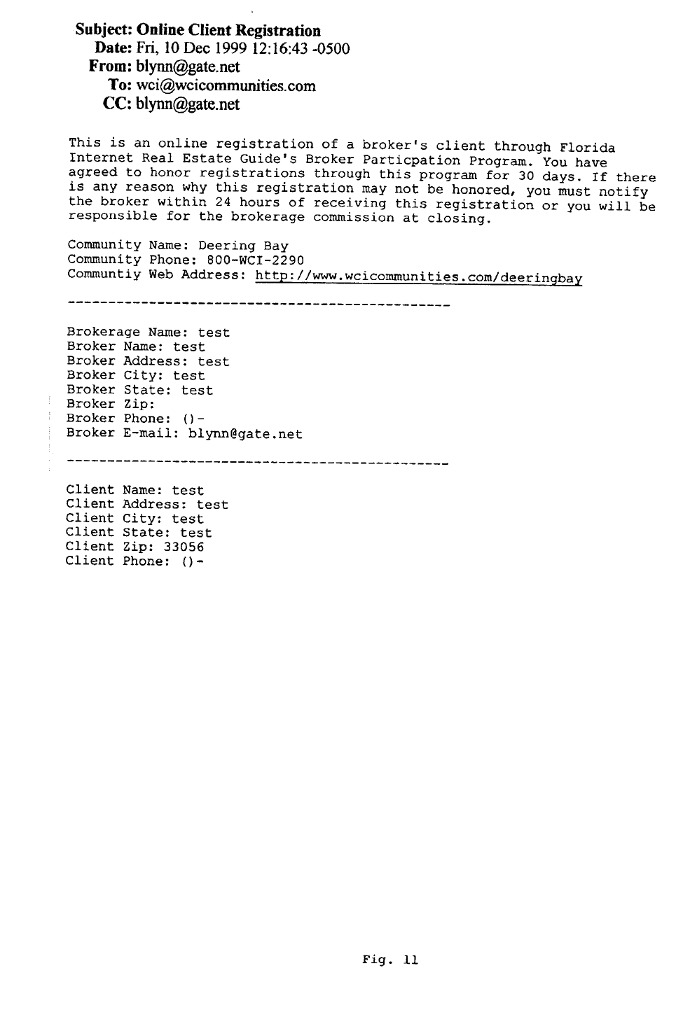

FIG. 10 is a web page that confirms that the registration of FIG. 9 was successful.

FIG. 11 is an email generated by an online registration and is sent to a homebuilder with copies to the real estate professional and Brokers Welcome.

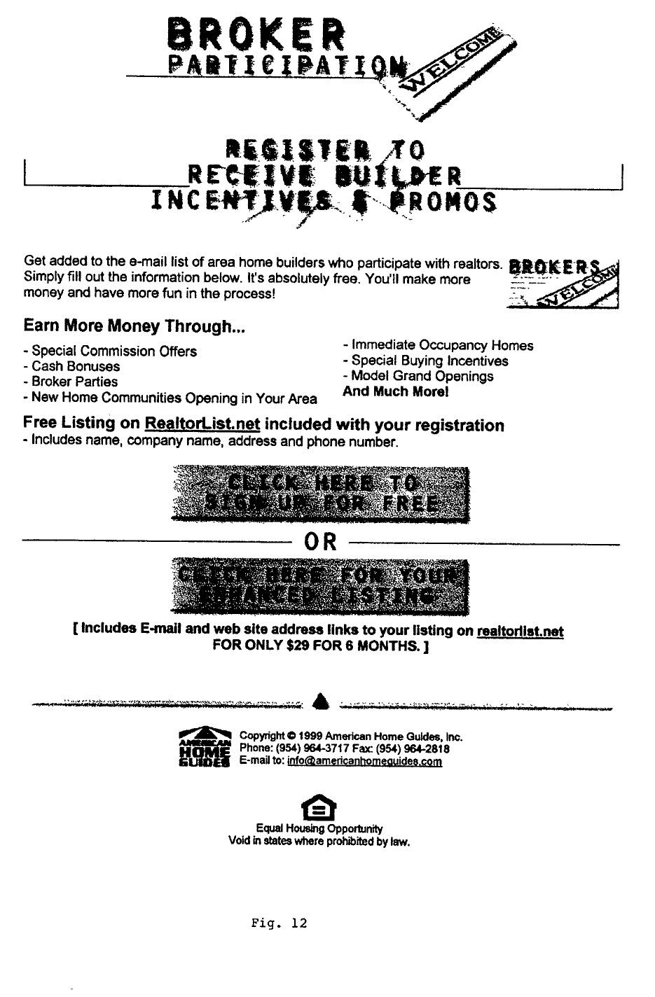

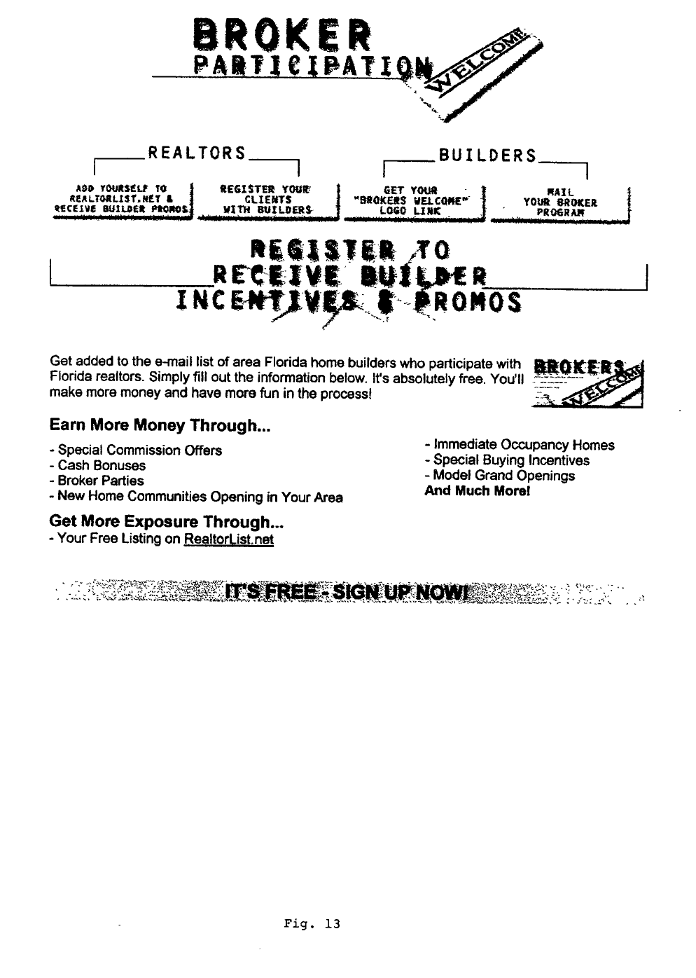

FIG. 12 is a web page that invites real estate professionals to add themselves to the email mailing list selecting a free or enhanced listing.

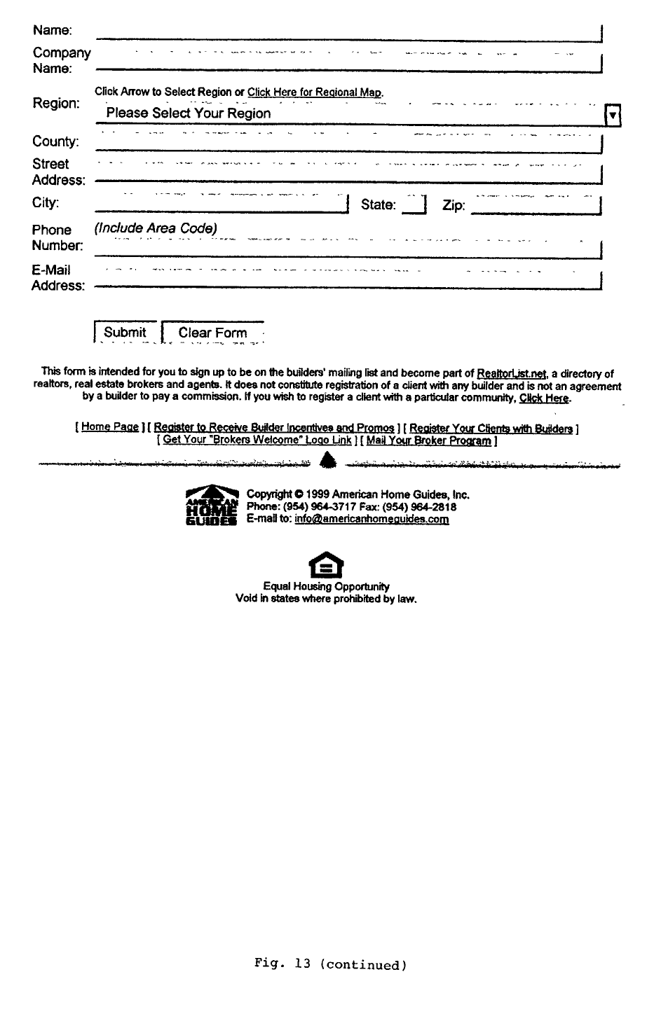

FIG. 13 is a web page that represents a free sign up page for real estate professionals to join the mailing list.

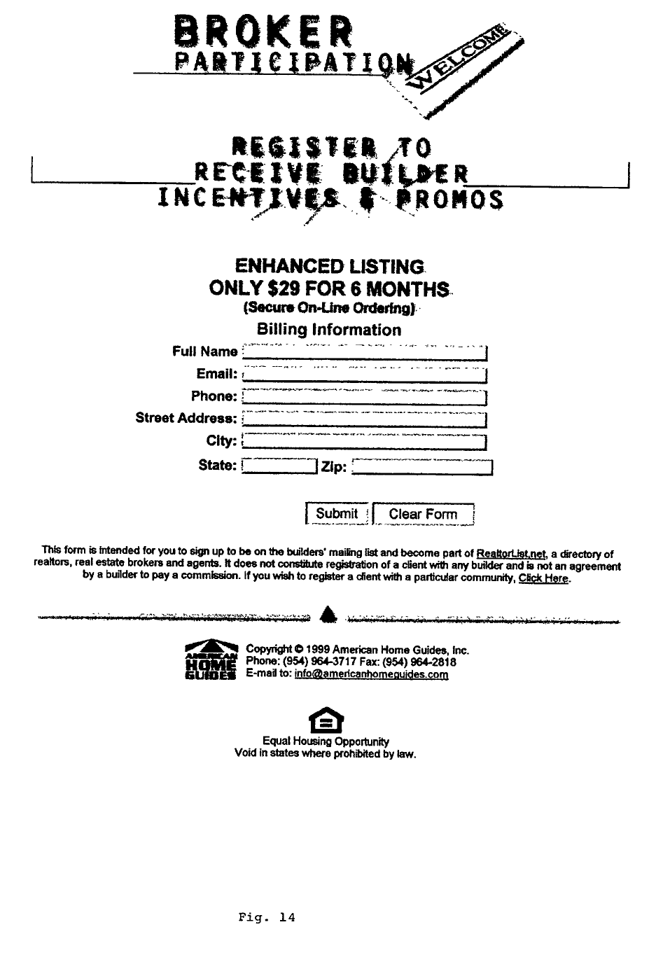

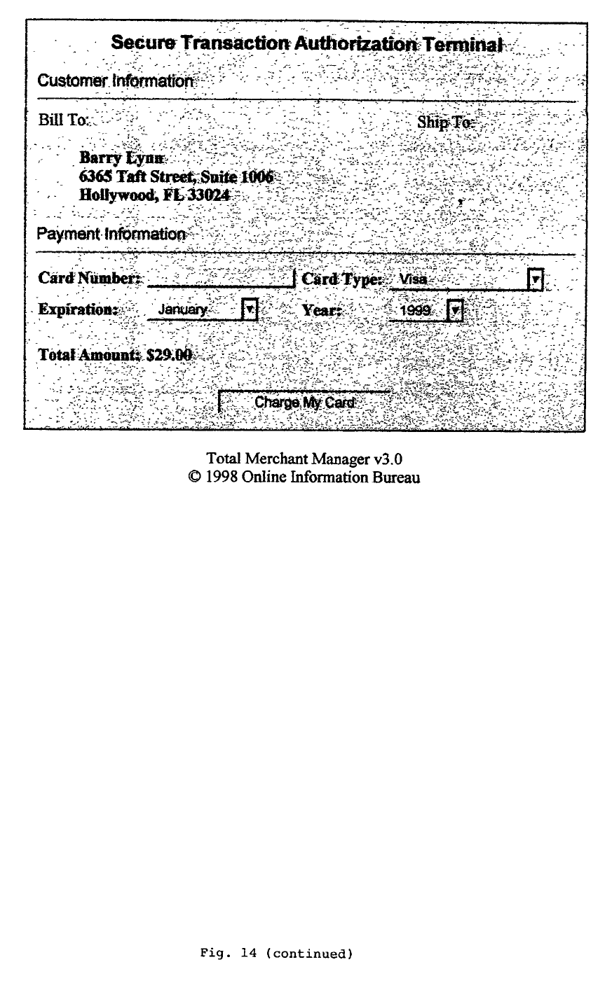

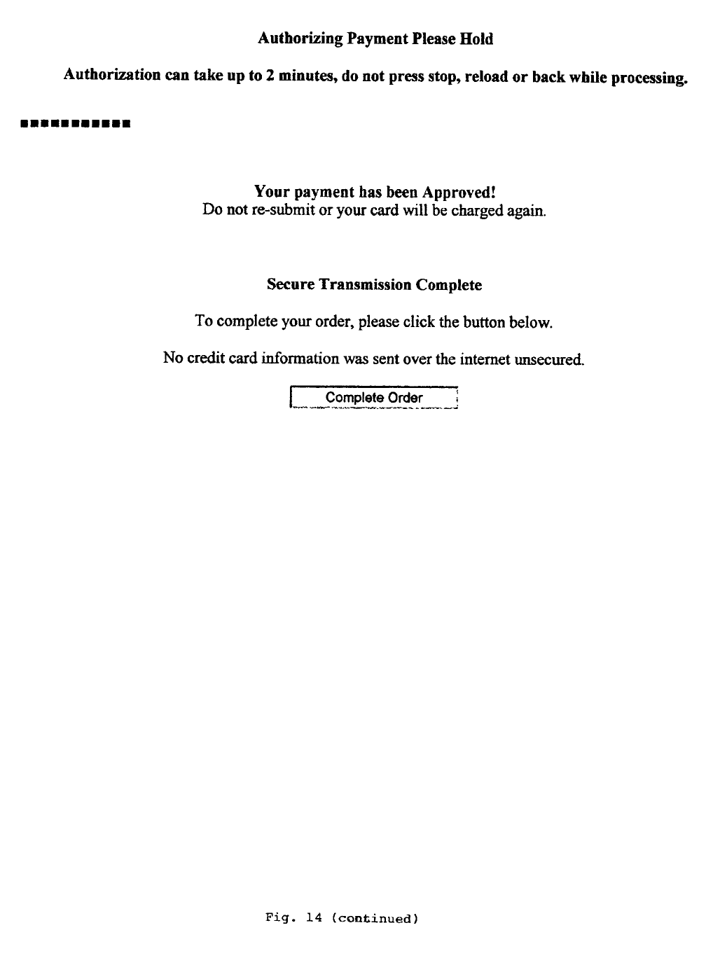

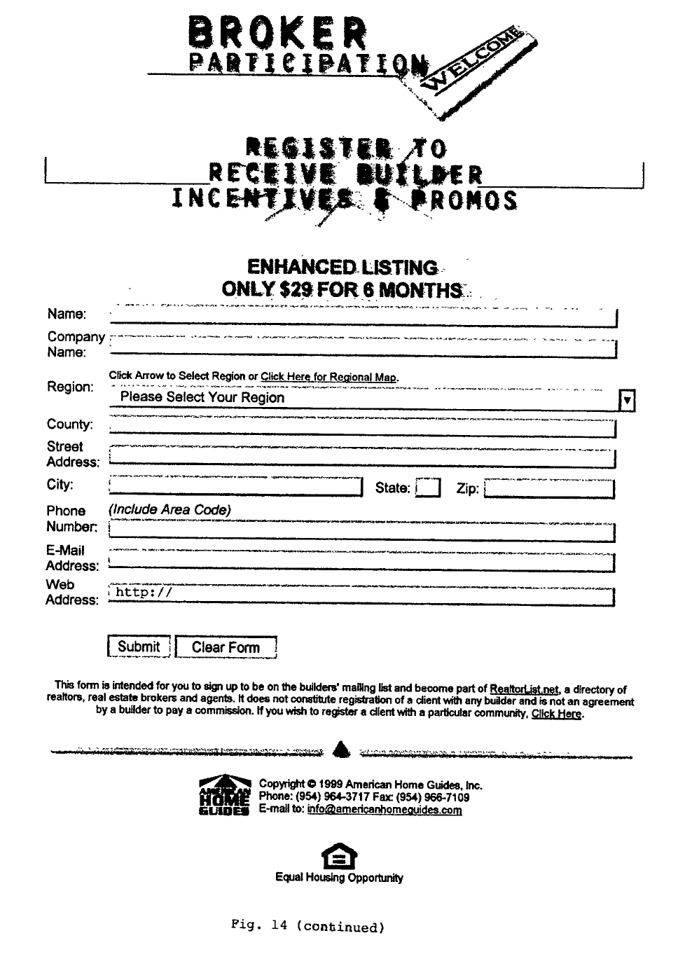

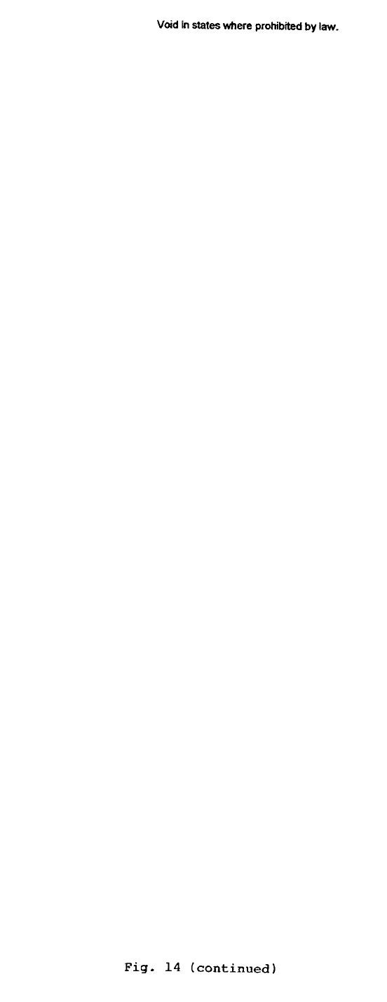

FIG. 14 are web pages that allow real estate professionals to purchase an enhanced listing on realtorlist.net while adding themselves to the mailing list.

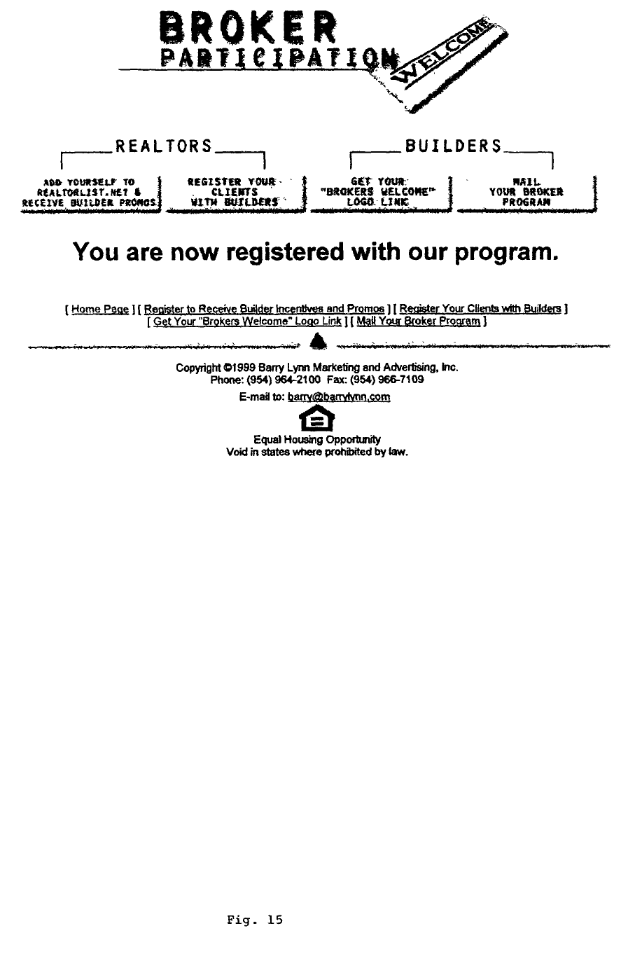

FIG. 15 is a web page that appears after real estate professionals submit their information to the mailing list.

### DETAILED DESCRIPTION

By way of illustrating and providing a more complete appreciation of the present invention and many of the attendant advantages thereof, the following detailed description is given concerning the novel systems and methods.

Usage instructions for both homebuilders and real estate professionals are maintained at, for example, a web site, such as, htt://www.brokerswelcome.com. From there, at lease four transactions can occur.

First, real estate professionals can privately add their names and contact information to the mailing list. The real estate professionals can enter, for instance, name, company, physical address, region within their state, email address and phone number. This information is stored in a private, flat file database accessible by the homebuilders selected by the professional.

Second, real estate professionals can privately register their clients with selected homebuilders. To accomplish this, the real estate professionals can search for new home communities by city or county, price range and type of home. The results display descriptive listings of communities where the home builders have agreed to permit online client registration. From these listings, the real estate professional can click on to the homebuilders web site, in private, for more information. Should the real estate professional decide to register his or her client at the community, he or she clicks a registration link above the community listing. This brings him or her to the registration form where he or she enters contact information about himself or herself and the client he or she is registering. Upon clicking the “submit” button the information is emailed to the homebuilder of choice in private.

Third, homebuilders obtain, for example, the html coding, which is a logo link, such as, “Brokers Welcome” to be added to their web sites. This logo link is designed to induce real estate professionals visiting the homebuilders web sites to click them in order to receive web pages that encourage them to add themselves to the mailing list. The information entered is stored on the server in a flat file format in private.

Fourth, homebuilders can privately send emails to real estate professionals who have added themselves to the list. The homebuilders have at least two choices: A text message or an animated “greeting card” with music. Both can contain hyperlinks.

The homebuilders begin by selecting the geographic region of the state that they want to access Then, the homebuilders enter the “headline” which will go into the subject field. Next, they enter the text message, and email address for return replies. The homebuilders then enter their usernames and passwords and click the “mail to realtors” button for immediate and private electronic transmission of selected information to targeted professionals.

A program, such as a CGI program, then bulk emails the message to all of the real estate professionals who have added themselves to the list for that region. If the homebuilders prefer to use animated cards, they can select which graphics they would like to send and then complete the same information as indicted above.

### EXAMPLE

An example of an embodiment of the present invention as set forth on the following pages will now be further illustrated. It should be apparent to those of skill in this art that the programs and supporting files utilized to carry out the objectives of this invention can be loaded onto any suitable device or computer hardware and can be formatted for compatibility with any server and search engine.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The invention described herein extends to all such modifications and variations as will be apparent to the reader skilled in the art, and also extends to combinations and subcombinations of the features of this description and the accompanying Figs and Example. Although preferred embodiments of the methods and systems of the present invention have been illustrated in the accompanying Figs. and described in the foregoing Detailed Description and Example, it will be understood that the invention is not limited to the embodiments disclosed, but is capable of numerous rearrangements, modifications and substitutions without departing from the spirit of the invention as set forth and defined by the following claims.

Having described my invention, I claim:

1) A system for electronic interaction between individuals for facilitating an exchange of selected information said system comprising:
means for transmitting and receiving selected information between the individuals over the internet; and
a device onto which said means is installed.

2) A system according to claim 1, wherein said means is the program set forth in the example.

3) A method for electronic interaction between individuals for facilitating an exchange of selected information said method comprising:
transmitting and receiving selected information between the individuals over the internet via means installed onto a device.

4) A method according to claim 3, wherein the means is the program set forth in the example.
